(19) United States
(12) Patent Application Publication
(10) Pub. No.: US 2021/0019684 A1
(43) Pub. Date: Jan. 21, 2021

(54) CLOUD BASED ELECTRONIC QUALITY ASSURANCE SURVEILLANCE SYSTEM

(71) Applicant: David M. Naseer, Iwakuni-Shi Yamaguchi-Ken (JP)

(72) Inventor: David M. Naseer, Iwakuni-Shi Yamaguchi-Ken (JP)

(21) Appl. No.: 16/932,276

(22) Filed: Jul. 17, 2020

Related U.S. Application Data
(60) Provisional application No. 62/876,674, filed on Jul. 20, 2019.

(51) Int. Cl. G06Q 10/06; G06Q 10/10; G06Q 50/18; G06Q 30/00; G06Q 50/26; G06Q 30/02; G06Q 10/08; G06F 21/62

(52) U.S. Cl. CPC G06Q 10/06395; G06Q 10/105; G06Q 50/18; G06F 21/6218; G06Q 50/26; G06Q 30/0282; G06Q 10/087; G06Q 30/018

(57) ABSTRACT

According to some embodiments, a military Cloud Based Electronic Quality Assurance Surveillance System is provided. The system comprises a plurality of electronic devices, a server comprising a processor and a non-transitory computer-readable medium comprising processor steps that when executed by the processor perform a method. The method comprises providing an audit function rating system that is numerical in nature to an area being audited. Assigning colors to numbers associated with the rating system. Automatically generating a letter to a subject matter expert associated with the area being audited and receiving an electronic response with corrective action information from the subject matter expert.

### BACKGROUND

Military aircraft are complex machines that have many onboard systems and numerous parts. For example, the F-35 Lightning II is an American family of single-seat, single-engine, all-weather stealth multirole combat aircraft that is intended to perform both air superiority and strike missions. It is also able to provide electronic warfare and intelligence, surveillance, and reconnaissance capabilities. Keeping track of NON-RIF spare parts, replacement parts and upgrades is an impossible task to handle given that parts have to be evaluated based on quality, price and reliability and vendors/suppliers of these parts may change with every new contract. Therefore, a reliable auditing system for aircraft parts is desirable.

### BRIEF DESCRIPTION OF THE DRAWINGS

FIG. 1 illustrates a system according to some embodiments.

FIG. 2 illustrates a process flow according to some embodiments.

FIG. 3 illustrates an embodiment of an auditing system.

### DETAILED DESCRIPTION

The present embodiments relate to an electronic auditing system for aircraft entitled “The F-35 Electronic Quality Assurance Surveillance Plan” and, in particular, the F-35 The present embodiments were developed for use by the F-35 Contracting Officer Representatives (CORs). The embodiments described herein relate to a web enabled auditing platform that may be accessed and used from a laptop or mobile device.

Currently, the F-35 JPO COR oversight process it consists of a paper-based auditing process. Audits are performed, manually documented, then data related to findings are manually computed. When reports are required, each report must be manually generated.

The present embodiments relate to an electronic auditing system that incorporates all the significant elements of this paper based, and has the added benefits of other audit functions. As the systems described herein, the present system is AS9100 based and it may use elements of the PEAR chart to standardize input across locations associated with the F-35 aircraft.

The present embodiments may be of capable of printing any report a Lead COR or a site CORs required For example, the present embodiments may generate the following reports: A QASP, COR report, the GGFR/COR/QAE record of surveillance, reports by site, reports by auditor, reports by question, reports indicating high risk areas and a trend analysis.

The present system may provide a unique QMS audit function, namely a standardized rating system that is numerical in nature. For example, in some embodiments high risk areas are designated as a 1 and lowest risk areas are designated as a 5. For clarity and simplicity, the numbers may be a assigned a color such as, for example, 1 is a red and 5 is a green. Once an audit rating is assigned, a letter may automatically be generated to a subject matter expert (SME) of the area audited. This letter may provide a list of corrective actions necessary and a timeframe for completion. The system described herein may also have a function to allow this SME to provide an electronic response with the corrective action information. Sending an electronic response with a corrective action may eliminate eliminates a need for paper copies, and provides a means for an information repository. The system also accounts for the number of non-Ready-For-Issue spare parts received; the manual processes used by the DoD to correct non-Ready-For-Issue problems; the manual processes used by the F-35 sites to keep aircraft flying when non-Ready-For-Issue spare parts are used and the associated increase in availability hours and the total F-35 aircraft availability hours. This is critical when there is a high turnover of COR personnel. Some specific functions are described below.

The system may document and store contractor performance data. Information stored, may be instantly accessed by any COR with appropriate access. The system keeps records of COR communications with contractors. The system may verify a government property processes. The system may record all audit areas of the key processes in an airplane (e.g., F-35) program and can be modified based on Joint Program Office (JPO) requirements. The system may document procedures and timelines when contractors are notified by the government of deficiencies. The system may monitor performance based on contract number and Contract Line Item Number (CLIN). The system may be site specific, as it is adaptable for each airplane (e.g., F-35) site. The system may verify that contractors are meeting milestones as it relates to specifics of each contract. The system may verify that corrective action is being appropriately taken by the contractor and provides the evidence for the Government to take appropriate action for nonconformity and for incentive fee assessment. The system may comprise a feature to obtain and document F-35 Warfighter Feedback. The system may maintain GGFR record of audits.

The present system comprises a dashboard for use by the Lead COR to obtain an immediate status of all F-35 sites. In some embodiments, the system may receive 545 or more different types of information from CORs on a monthly basis and this information is not arranged in order of risk.

Additional features may comprise an aircraft readiness verification based on tail number, performing trend analysis, comparison reports, accessible from government or authorized civilian mobile devices and can be easily modified to use on a variety of web services and has a civilian application should the need arise.

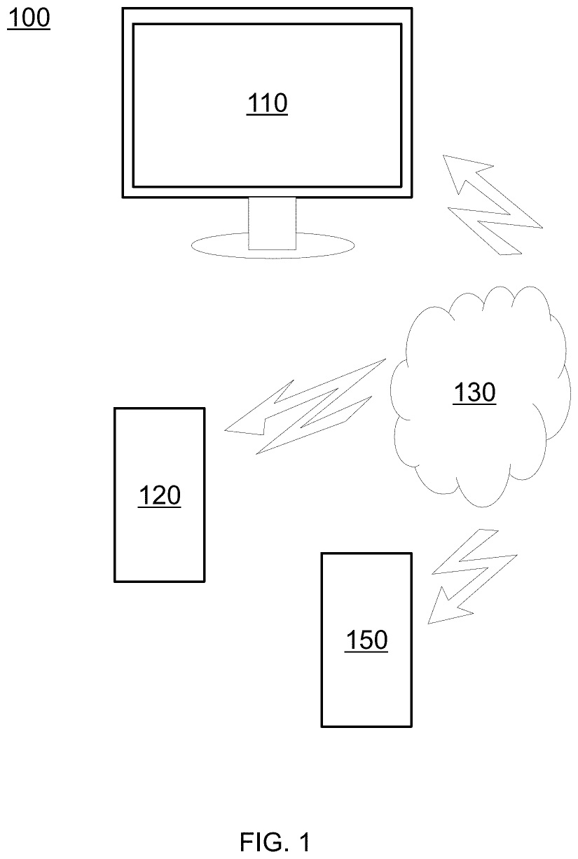

Now referring to FIG. 1, an embodiment of an cloud based electronic quality assurance surveillance system 100 is illustrated. As illustrated in FIG. 1, a first computing device 110 and a second computing device 120 may be communicatively coupled to a communication network 130. The communication network 130 may comprise any wired or wireless communication network that may be used for communication purposes between electronic devices. For example, the network 130 may comprise, but is not limited to, a wired and/or wireless mesh network, LAN, MAN, WAN, or the Internet.

For purposes of illustration, the first computing device 110 may comprise a desktop computer, a laptop or a tablet. The first computing device 110 may function as a viewing platform for viewing information in the Cloud Based Electronic Quality Assurance Surveillance System 100. The second computing device 120 may comprise a mobile device such as a tablet or a smart phone. In some embodiments, the second computing device 120 may function as a portable platform for viewing information on the Cloud Based Electronic Quality Assurance Surveillance System 100. The first computing device 110 and the second computing device 120 may communicate with a back-end or remote server 150 via the communication network 130 to receive and transmit information associated with a plurality of sites, a plurality of parts and a plurality of vendors.

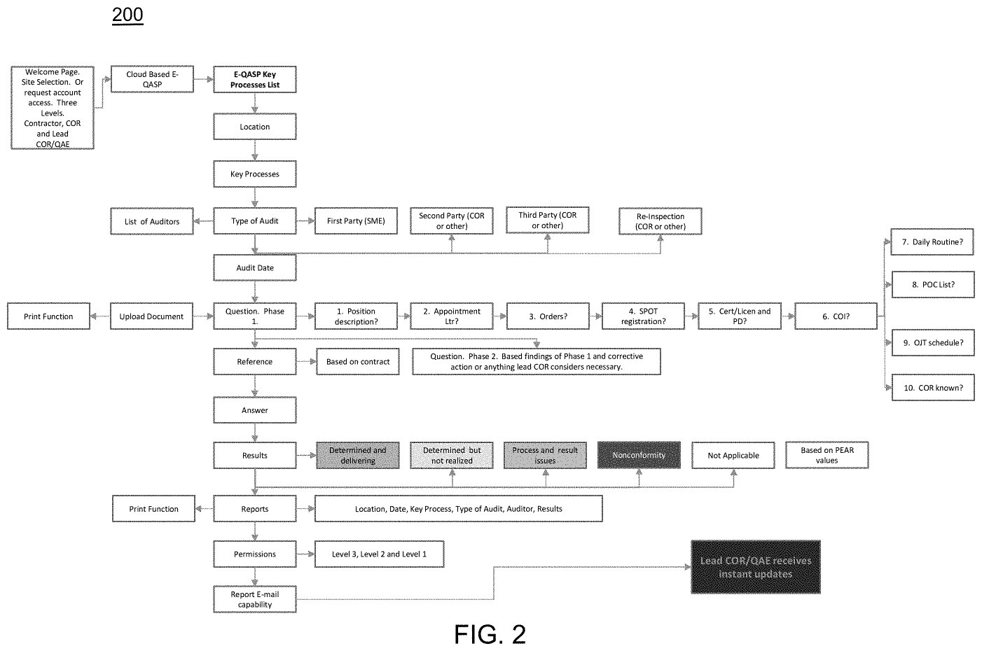

Now referring to FIG. 2, a method 200 that might be performed by the Cloud Based Electronic Quality Assurance Surveillance System 100 described with respect to FIG. 1 is illustrated according to some embodiments. The method described herein does not imply a fixed order to the steps, and embodiments of the present invention may be practiced in any order that is practicable. Note that any of the methods described herein may be performed by hardware, software, or any combination of these approaches. For example, a non-transitory computer-readable storage medium may store thereon instructions that when executed by a machine result in performance according to any of the embodiments described herein.

Method 200 may begin by determining an access level such as, but not limited to, Contractor, COR or Lead COR/QAE. Method 200 may provide options to enter, view or report data associated with the variety of functions described above. For example, method 200 may initiate corrective action or other actions that a COR considers necessary.

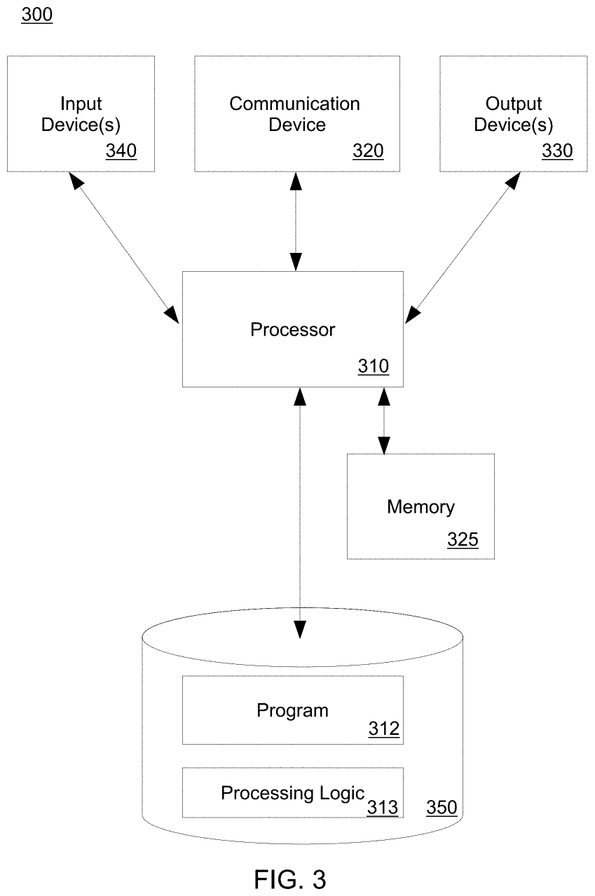

Note the embodiments described herein may be implemented using any number of different hardware configurations. For example, FIG. 3 illustrates a back-end server 300 that may be, for example, associated with the Cloud Based Electronic Quality Assurance Surveillance System 100 of FIG. 1. The server 300 may provide a technical and commercial advantage by being able to manage a constant flow of changing vendors, work sites and design changes associated with a military aircraft.

The server 300 may comprise a processor 310 (“processor”), such as one or more commercially available Central Processing Units (CPUs) in the form of one-chip microprocessors, coupled to a communication device 320 configured to communicate via a communication network (not shown in FIG. 3). The communication device 320 may be used to communicate, for example, with one or more machines on a network. The server 300 further includes an input device 340 (e.g., a mouse and/or keyboard to enter answers to a visual acuity test) and an output device 330 (e.g., to output and display the data and/or alerts).

The processor 310 also communicates with a memory 325 and storage device 350 that stores data 313. The storage device 350 may comprise any appropriate information storage device, including combinations of magnetic storage devices (e.g., a hard disk drive), optical storage devices, mobile telephones, and/or semiconductor memory devices. The storage device 350 may store a program 312 and/or processing logic 313 for controlling the processor 310. The processor 310 performs instructions of the programs 312, 313, and thereby operates in accordance with any of the embodiments described herein. For example, the processor 310 may receive airplane related data may provide alerts via the instructions of the programs 312 and processing logic 313.

The programs 312, 313 may be stored in a compiled, compressed, uncompiled and/or encrypted format or a combination. The programs 312, 313 may furthermore include other program elements, such as an operating system, a database management system, and/or device drivers used by the processor 310 to interface with peripheral devices.

As will be appreciated by one skilled in the art, the present embodiments may be embodied as a system, method or computer program product. Accordingly, the embodiments described herein may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the embodiments described herein may take the form of a computer program product embodied in one or more computer readable medium(s) having computer readable program code embodied thereon.

The process flow and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be noted that any of the methods described herein can include an additional step of providing a system comprising distinct software modules embodied on a computer readable storage medium; the modules can include, for example, any or all of the elements depicted in the block diagrams and/or described herein. The method steps can then be carried out using the distinct software modules and/or sub-modules of the system, as described above, executing on one or more hardware processors. Further, a computer program product can include a computer-readable storage medium with code adapted to be implemented to carry out one or more method steps described herein, including the provision of the system with the distinct software modules.

This written description uses examples to disclose multiple embodiments, including the preferred embodiments, and also to enable any person skilled in the art to practice the invention, including making and using any devices or systems and performing any incorporated methods. Aspects from the various embodiments described, as well as other known equivalents for each such aspects, can be mixed and matched by one of ordinary skill in the art to construct additional embodiments and techniques in accordance with principles of this application.

Those in the art will appreciate that various adaptations and modifications of the above-described embodiments can be configured without departing from the scope and spirit of the claims. Therefore, it is to be understood that the claims may be practiced other than as specifically described herein.

What is claimed is:

1. A military Cloud Based Electronic Quality Assurance Surveillance System comprising:
a plurality of electronic devices;
a server comprising a processor; and
a non-transitory computer-readable medium comprising processor steps that when executed by the processor perform a method, the method comprising:
providing an audit function rating system that is numerical in nature to an area being audited;
assigning colors to numbers associated with the rating system;
automatically generating a letter to a subject matter expert associated with the area being audited; and
receiving an electronic response with corrective action information from the subject matter expert.

2. The military Cloud Based Electronic Quality Assurance Surveillance System of claim 1, wherein the letter includes a list of corrective actions necessary and a timeframe for completion.

3. The military Cloud Based Electronic Quality Assurance Surveillance System of claim 1, wherein the method further comprises storing contractor performance data.

4. The military Cloud Based Electronic Quality Assurance Surveillance System of claim 3, wherein the performance data is only accessed by a user with appropriate access.

5. The military Cloud Based Electronic Quality Assurance Surveillance System of claim 1, wherein the method further comprises storing communication records between Contracting Officer Representatives (COR) and contractors.

6. The military Cloud Based Electronic Quality Assurance Surveillance System of claim 1, wherein the method further comprises storing procedures and timelines when contractors are notified of deficiencies.

7. The military Cloud Based Electronic Quality Assurance Surveillance System of claim 1, wherein the system monitor performance based on contract number and Contract Line Item Number (CLIN).

8. The military Cloud Based Electronic Quality Assurance Surveillance System of claim 1, wherein the system is site specific.

9. The military Cloud Based Electronic Quality Assurance Surveillance System of claim 1, wherein the method further comprises verifying that contractors are meeting milestones associated with a contract.

10. The military Cloud Based Electronic Quality Assurance Surveillance System of claim 1, wherein the method further comprises verifying that corrective action is being appropriately taken by a contractor and providing evidence for a government to take appropriate action for nonconformity.

11. A non-transitory computer-readable medium comprising processor steps that when executed by a processor perform a method, the method comprising:
providing an audit function rating system that is numerical in nature to an area being audited;
assigning colors to numbers associated with the rating system;
automatically generating a letter to a subject matter expert associated with the area being audited; and
receiving an electronic response with corrective action information from the subject matter expert.

12. The non-transitory computer-readable medium of claim 11, wherein the letter includes a list of corrective actions necessary and a timeframe for completion.

13. The non-transitory computer-readable medium 11, wherein the method further comprises storing contractor performance data.

14. The non-transitory computer-readable medium of claim 13, wherein the performance data is only accessed by a user with appropriate access.

15. The non-transitory computer-readable medium of claim 11, wherein the method further comprises storing communication records between Contracting Officer Representatives (COR) and contractors.

16. The non-transitory computer-readable medium of claim 11, wherein the method further comprises storing procedures and timelines when contractors are notified of deficiencies.

17. The non-transitory computer-readable medium of claim 12, wherein the system monitor performance based on contract number and Contract Line Item Number (CLIN).

18. The non-transitory computer-readable medium of claim 11, wherein the system is site specific.

19. The non-transitory computer-readable medium of claim 11, wherein the method further comprises verifying that contractors are meeting milestones associated with a contract.

20. The non-transitory computer-readable medium of claim 11, wherein the method further comprises verifying that corrective action is being appropriately taken by a contractor and providing evidence for a government to take appropriate action for nonconformity.
